(19) United States
(12) Patent Application Publication
(10) Pub. No.: US 2016/0189282 A1
(43) Pub. Date: Jun. 30, 2016

(54) DEVICE FOR AUTOMATICALLY TRANSMITTED ORDERS AND BOOKINGS

(71) Applicant: Carlo Giuseppe BRIANZA, Milano (IT)

(72) Inventor: Carlo Giuseppe BRIANZA, Milano (IT)

(21) Appl. No.: 14/914,952

(22) PCT Filed: Aug. 1, 2013
(86) PCT No.: PCT/EP2013/066187

§ 371 Date: Feb. 26, 2016

(30) Foreign Application Priority Data
Aug. 3, 2012 (IT) FI2012A000160

(51) Int. Cl. G06Q 30/06

(52) U.S. Cl. CPC G06Q 30/0635

(57) ABSTRACT

The present invention relates to an apparatus comprising an Internet server and a device associated with said Internet server, adapted to allow a user to automatically order goods and/or services so as to reduce purchasing times and difficulty.

### FIELD OF THE INVENTION

The present invention relates to the technical field of electronic devices provided with connection functions and user interface.

### STATE OF THE ART

Communication possibilities have multiplied over the past years with the development of the Internet. In particular and especially, the possibilities for selling products and services using the Internet as promotional and commercial channel have multiplied.

Until a short while ago, goods or services were purchased by individuals or businesses mainly by telephone or fax, while today purchasing online is an increasingly more consolidated, popular choice. Purchasing online allows to access huge catalogues of goods and services, generally allows to obtain lower prices than normal sales, and allows to made choices directly from home without needing to go to retailers or contact them by telephone or fax.

Purchasing online thus allows to shorten times with respect to traditional purchases—which requires to go to the retailer—and also with respect to purchasing by telephone, which requires a number of actions to be performed before it is possible: locating the telephone number, calling the identified telephone number, explaining to the telephone operator what and how many goods and services the customer is interested in, asking for prices, discounts, delivery time etc., agreeing the payment methods and times.

However, even online or computerized purchases may not be immediate. The following actions are indeed normally needed: turning on the personal computer, waiting for the personal computer to boot up and be available, loading a browser to view the concerned vendors website on the personal computer screen, searching for the goods of interest, choosing amounts and shipment method, sending the order.

Performing the actions above may be difficult, or even impossible, if the user is not expert or at least accustomed to using a personal computer. There are indeed still large groups of people who cannot use a personal computer, such as the elderly or the disabled.

The technical problem that the present invention aims at solving thus relates to the lack of a device adapted to order goods and services online, thus benefiting from the several sales advantages of the Internet without having the above-described drawbacks, which relate, on one hand, to the difficulty for many users to interface with complex devices, such as personal computers, smartphones etc., and, on the other hand, to the sometimes very long time needed to perfect an online purchase. The present invention solves the aforesaid technical problem by introducing a device which make the online purchasing of goods and/or services immediate for any type of user.

The method of using the device according to the present invention allows much faster times than a telephone order or a computerized order, and ensures simplicity and user-friendliness such as to make it useable also by elderly users, users with poor or no knowledge of how to use computers or smartphones, by disabled users and any other category of users who, for various reasons, have problems in interacting with the Internet or simply want or need to save time.

The present invention can be applied in homes—to allow users to order goods or services, such as for example orders from a restaurant which can be then delivered home or picked up by the user at the restaurant itself—and businesses, to allow, for instance, a network of agents or group of shops to order given amounts of goods from a supplier or distributor so as to reduce times and costs of procurement and to allow personnel of lower professional/educational levels to perform these operations.

### BRIEF DESCRIPTION OF THE DRAWINGS

FIG. 1 shows a functional block chart of the apparatus according to the present invention comprising an Internet server 10 and a device 11 provided with a user interface and means adapted to connect to said Internet server.

FIG. 2 shows a functional block chart of the device 11 according to the invention.

### SUMMARY OF THE INVENTION

The present invention relates to an apparatus adapted to allow a user to automatically order goods and/or services so as to reduce purchasing times and difficulty.

### DETAILED DESCRIPTION OF THE INVENTION

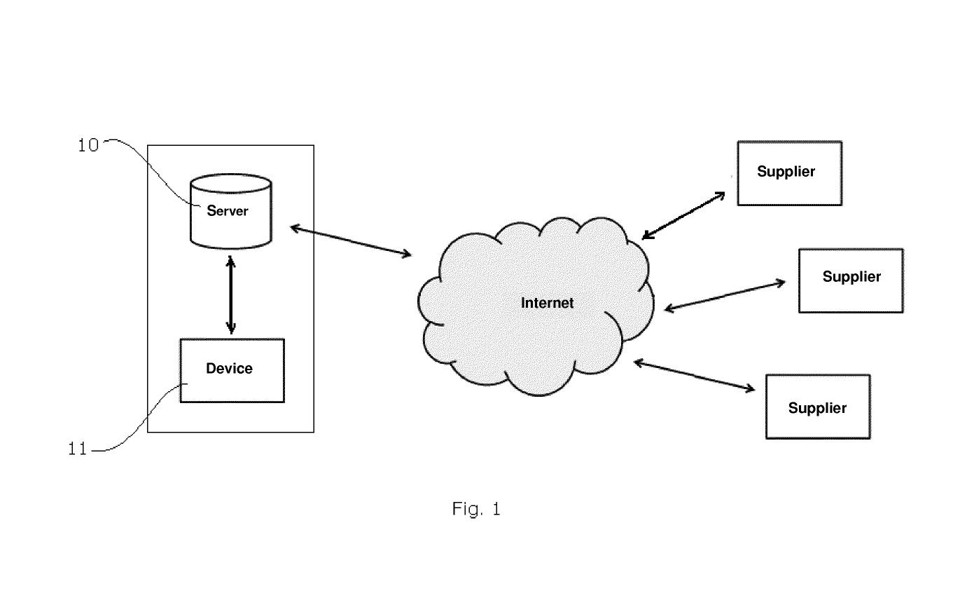

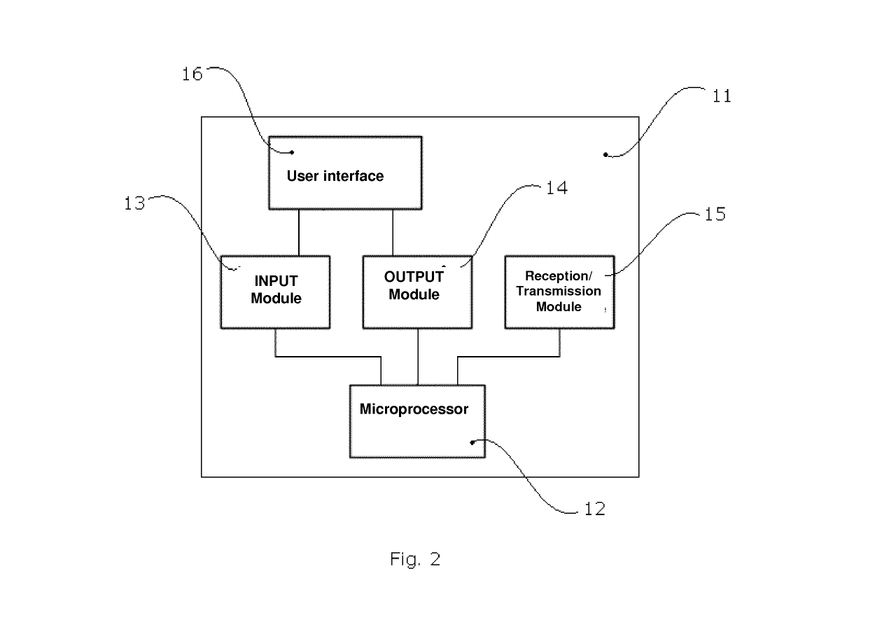

With reference to accompanying FIGS. 1 and 2, the apparatus according to the present invention comprises the following parts: an Internet server 10 and a device 11 provided with a user interface 16 and means adapted to connect to said Internet server 10.

More in detail, said device 11 comprises a control module 12 based on at least one microprocessor; an input module 13, associated with said user interface 16 and said control module 12 and adapted to translate the settings given by the user by means of said user interface 16 into commands for said control module 12; and an output module 14, associated with said user interface 16 and said control module 12 and adapted to translate signals from said control module into data and information to said user interface 16; a reception/transmission module 15 adapted to communicate with said Internet server 10 so as to connect said device 11 to the Internet. Said reception/transmission module is adapted to establish a connection with said Internet server 10 in both wired mode and wireless mode according to the known communication protocols, Wi-Fi, Bluetooth or ZigBee, etc., or by means of the cellular telephone network or even by means of RFID/NFC technology.

Said control module 12, input module 13 and output module 14 may be integrated in said microprocessor.

Said user interface preferably comprises an input section, adapted to receive commands from the user and comprising a keyboard—of the type with a single key or button or with multiple keys or buttons—or a multiple switch or a simple push button, and an output section, adapted to provide information to said user and comprising at least one display, e.g. of the liquid crystal type, possibly of the touchscreen type or at least one signaling LED and possibly also an acoustic signaling device.

Preferably, said device 11 is small in size so as to be easily arranged wherever it is needed to be easily reachable and useable.

The present invention may be provided to access one or several suppliers of goods and services; said user interface will be provided so as to immediately access each of the suppliers who can be contacted via the present invention.

In the simplest embodiment of the present invention, said device 11 is adapted to order only one amount of a single product/service from a single supplier. In this case, said user interface may be reduced to one button for sending the order and a signaling LED to inform the user that the order has been received.

In other preferred embodiments, instead, said user interface comprises a display for viewing the available products or services and a keyboard by means of which it is possible to interact with said display to select the supplier, the product and the concerned amount, in addition to possible further parameters, such as the day and time of delivery, etc. or again to customize the viewing of the offered goods and/or services so as to create groups, set repeat purchases etc.

The device 11 according to the present invention can thus connect to said Internet server 10 which, in turn, sends the order to the supplier, who then clears the order in the terms set by the user. The order may be sent to the supplier in various manners: via computer, by means of a web page or email message, or via text message, by sending to a printer connected to said Internet server 10 or even by means of other systems defined according to the needs of the suppliers themselves.

The present invention is simple and useful to be managed by the supplier of goods and services who, by accessing said Internet server 10 after appropriate identification, can update the list of goods/services which can be ordered, or activate or deactivate the ordering service by means of the present invention according to specific times or seasons.

The device 11 according to the present invention is univocally identified so as to be combined with a single specific user. Furthermore, said device 11 may be combined with one or more suppliers of goods and/or services.

The operation of the present invention is apparent: the user may interact with the user interface of said device 11 so as to order goods and/or services immediately and without the complications and waste of time related to the interaction with complex instruments, such as personal computers, smartphones, etc. or to the ordering of purchases by telephone or fax.

Said user interface may be provided with various degrees of complexity according to the type of user who will use it and the number of suppliers and goods and/or services which will be made available to the user, so that this invention can be adapted to any need on home or business level.

The device according to the present invention is a stand-alone device which is adapted to connect to the internet and work independently from any auxiliary external devices. Furthermore, the device according to the present invention provides the user with an extremely simple user interface, which can be as simple as one button and one light indicator, adapted to be used-friendly for every kind of user regardless his/her age, skill, ability.

For more expert users, the apparatus according to the present invention may offer the possibly of autonomously modifying the menu or the available options which can be selected on said device 11. In this case, if the suppliers of goods and/or services allow to, the users may customize the device 11 by accessing said Internet server 10 by means of their personal computer or smartphone.

In this case, if the supplier provides a catalogue containing a number of goods and/or services larger than that currently available on the device 11, the users may associate goods and/or services and/or suppliers to their device additionally or alternatively to those currently available according to the users' requirements and needs by connecting to said Internet server 10.

1. An apparatus for purchasing goods and/or services, comprising an Internet server and a device comprising a user interface, a control module based on at least one microprocessor; an input module, associated with said user interface and with said control module and adapted to translate the settings given by the user by means of said user interface into commands for said control module; an output module, associated with said user interface and with said control module and adapted to translate the signals from said control unit into data and information for said user interface; a reception/transmission module adapted to communicate with said Internet server so as to connect said device to at least one supplier of goods and/or services by means of the Internet network and allow said supplier of goods and/or services to send an order or booking for goods and/or services.

2. The apparatus according to claim 1, wherein said device comprises means adapted to univocally identify it so that it can be matched with a specific individual user.

3. The apparatus according to claim 1, wherein said device can be matched with one or more suppliers of goods and/or services.

4. The apparatus according to claim 1, wherein said reception/transmission module is adapted to establish a connection with said Internet server in both wired mode and wireless mode by means of the cellular telephone network or by means of RFID/NFC technology or according to the protocols chosen from the group comprising Wi-Fi, Bluetooth or ZigBee protocols.

5. The apparatus according to claim 1, wherein said operation of sending an order or a booking for goods and/or services to said supplier of goods and/or services occurs according to modes chosen from the group comprising: sending a web page or an e-mail message containing said order or booking, sending a text message containing said order or booking, sending a printed page containing said order or booking to a printer connected to said Internet server.

6. The apparatus according to claim 1, wherein said control modules, for input and output operations, are integrated in said microprocessor.

7. The apparatus according to claim 1, wherein said user interface comprises an input section adapted to receive commands from the user and an output section adapted to supply information to the user.

8. The apparatus according to claim 7, wherein said input section comprises at least one device chosen from the group comprising a keyboard, of the type with a single key or button or with multiple keys or buttons, a multiple switch, a push button and a touch screen-type display, taken individually or in combination, and said output section comprises at least one device chosen from the group comprising a display, at least one signaling LED and an acoustic signaling device, taken individually or in combination.

9. The apparatus according to claim 1, wherein said Internet server is remotely accessible by both said supplier of goods and/or services, in order to update the list of goods/services which can be ordered, or activate or deactivate the ordering service, and by said user, in order to associate his/her own device with additional or alternative goods and/or services and/or suppliers to those currently available.
